(19) United States
(12) Patent Application Publication
(10) Pub. No.: US 2003/0211296 A1
(43) Pub. Date: Nov. 13, 2003

(54) Identification card printed with jet inks and systems and methods of making same

(76) Inventors: Robert Jones, Andover, MA (US); Daoshen Bi, Boxborough, MA (US); Dennis Mailloux, Westminster, MA (US)

Correspondence Address: DIGIMARC CORPORATION, 19801 SW 72ND AVENUE, SUITE 100, TUALATIN, OR, 97062, US

(21) Appl. No.: 10/289,962

(22) Filed: Nov. 6, 2002

Related U.S. Application Data
(60) Provisional application No. 60/379,704, filed on May 10, 2002.
(60) Provisional application No. 60/379,646, filed on May 10, 2002.

(51) Int. Cl. B41M 5/20

(52) U.S. Cl. 428/195.1; 503/200

(57) ABSTRACT

The present invention relates to assembling identification documents in an over-the-counter issuing environment. In one implementation of the present invention, we provide an identification document capable of being printed by an ink jet printer-based system in an over-the-counter environment. The identification document comprises a core layer and a first indicium. The core layer has a first surface, and the first indicium is printed directly onto at the first surface of the core layer. The first indicium is formed by a pigmented ink jet ink. The core material can have an affinity for a particular substance (e.g., water) and the pigmented jet ink can include that substance (e.g., an aqueous-based ink jet ink). An identification document substrate can receive pigmented ink jet ink from an ink jet printer without requiring a receiver layer or receiver coating on the substrate. The absence of the receiver layer allows for direct bonding of additional layers, such as laminates, to an unprinted substrate, thereby not interfering with the bonding mechanism of the laminate to the substrate. Identification documents formed in this manner can meet or exceed all AAMVA, ANSI, and ISO requirements.

### RELATED APPLICATION DATA

The present application is related to U.S. patent application Ser. Nos. 09/747,735, filed Dec. 22, 2000, 09/602,313, filed Jun. 23, 2000, and 10/094,593, filed Mar. 6, 2002, U.S. Provisional Patent Application No. 60/358,321, filed Feb. 19, 2002, as well as U.S. Pat. No. 6,066,594. Each of the above U.S. Patent documents is herein incorporated by reference.

### CROSS REFERENCE TO RELATED APPLICATION

This application claims the priority of the following U.S. Provisional Applications, the contents of which are incorporated herein by reference in their entirety.

Identification Card Printer-Assembler For Over-The-Counter Card Issuing (Application No. 60/379,646, Attorney Docket No. P0612—Inventors: Dennis Mailloux, Daoshen Bi and Robert Jones), filed May 10, 2002; and

Application of pigmented jet inks to ID cards (Application No. 60/379,704, Attorney Docket No. P0640—Inventors Daoshen Bi, Dennis Mailloux, and Robert Jones), filed May 10, 2002.

### TECHNICAL FIELD

The present invention generally relates to identification and security documents, and in particular, relates to printing substrates such as identification document substrates with pigmented ink jet printer inks.

### BACKGROUND

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening, and prior to boarding their flight. In addition, because we live in an ever-evolving cashless society, ID documents are used to make payments, access an ATM, debit an account, or make a payment, etc.

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

In the production of images useful in the field of identification documentation, it is oftentimes desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16, 1993 to J. W. Luening, et al. All of the aforementioned documents are hereby incorporated by reference.

The advent of commercial apparatus (printers) for producing dye images by thermal transfer has made relatively commonplace the production of color prints from electronic data acquired by a video camera. In general, this is accomplished by the acquisition of digital image information (electronic signals) representative of the red, green and blue content of an original, using color filters or other known means. These signals are then utilized by a printer having a plurality of small heating elements (e.g., pins) for imagewise heating of each of a series of donor sheets (respectively, carrying sublimable cyan, magenta and yellow dye). The donor sheets are brought into contact with an image-receiving element (which can, for example, be a substrate) which has a layer for receiving the dyes transferred imagewise from the donor sheets. Thermal dye transfer methods as aforesaid are known and described, for example, in U.S. Pat. No. 4,621,271, issued Nov. 4, 1986 to S. Brownstein and U.S. Pat. No. 5,024,989, issued Jun. 18, 1991 to Y. H. Chiang, et al. Each of these patents is hereby incorporated by reference.

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents is manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document.

OTC identification documents of the types mentioned above can take a number of forms, depending on cost and desired features. Some OTC ID documents comprise highly plasticized poly(vinyl chloride) or have a composite structure with polyester laminated to 0.5-2.0 mil (13-51 .mu.m) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the printhead, holographic hot stamp foils (0.125-0.250 mil 3-6 mu.m), or a clear polyester laminate (0.5-10 mil, 13-254 .mu.m) supporting common security features. These last two types of protective foil or laminate sometimes are applied at a laminating station separate from the printhead. The choice of laminate dictates the degree of durability and security imparted to the system in protecting the image and other data.

FIGS. 1 and 2 illustrate a front view and cross-sectional view (taken along the A-A line), respectively, of an exemplary prior art OTC identification document 1. In FIG. 1, the prior art OTC ID document 1 includes a photographic image 2, personal information 3, and a security pattern 3 (for example, a printed pattern comprising a tightly printed pattern of finely divided printed and unprinted areas in close proximity to each other, such as a fine-line printed security pattern as is used in the printing of banknote paper, stock certificates, and the like). If desired, the security pattern 4 can be part of different pattern designs (e.g., filigree, guilloche) and can be printed in different inks (e.g., UV ink).

Referring to FIG. 2, the prior art OTC ID document 1 comprises a pre-printed core 5 (such as, for example, white PVC material) that is, for example, about 30 mil thick. The core 5 is laminated with clear PVC material 6, which, by way of example, is about 1-5 mil thick. The composite of the core 5 and clear PVC material 6 form a so-called “card blank” 7 that can be about 30 mils thick. Information 8 is printed on the card blank 7 using Dye Diffusion Thermal Transfer (“D2T2”) printing (which is described further below). To protect the information 8 printed by D2T2 printing, an additional layer of overlaminate 9 is coupled to the card blank 7 and D2T2 printing using, for example, 1 mil of adhesive (not shown).

One type of OTC identification document, available from the assignee of the present invention as a “Desktop Security Card (DSC), has a core layer (also referred to as “substrate”) formed from an opaque sheet of printable silica-filled polyolefin, such as the materials sold commercially by PPG Industries, Inc., Pittsburgh, Pa. under the Registered Trade Mark “TESLIN”. In the DSC card, printing of the ID document in OTC environments is achieved with, dye sublimation printers—also known as Dye Diffusion Thermal Transfer (“D2T2”) printers. Dye sublimation is a thermal imaging technology that allows for the production of photographic quality images. Dye sublimation typically employs a set of panels (or ribbons) that are coated with a dye (e.g., cyan, magenta, yellow, black, etc.) that can be transferred to a substrate by the application of heat (and sometimes pressure) from a stylus or thermal print head at a discrete point. The dye will sublimate and migrate into the substrate, where it is chemically bound to the substrate or, if provided, to a receiver coating. Typically, printing with successive color panels across the document creates an image in or on the document's surface. Printing quality of the printed image may depend at least on an ability of a mechanical printer system to accurately register a printing sequence, e.g., yellow, magenta, cyan, and black. Commonly assigned U.S. Pat. No. 6,066,594 describes this type of OTC identification document in greater detail, and the contents of this patent are incorporated hereto by reference in their entirety.

Presently available dye diffusion printing, however, can be expensive, especially as compared to the cost of presently available inkjet printers. Part of the expense is attributable to a short life span of the dye diffusion ribbons, e.g., the ribbons can only be used for a few prints (sometimes only one print) before they are depleted. This sometimes occurs because the printing of a single card may require a full set of the D2T2 color panels, resulting in a high percentage of unused (and, unfortunately, wasted) imaging materials. These systems also diffuse dye to expensive PCV or other, more expensive substrates.

Still another important issue with OTC ID documents is their durability. Many ID documents, such as driver's licenses, can be subjected to environmental conditions, such as humidity, water, dirt, and heat that can cause significant damage to the laminate, images, and/or text on the card. Such environmental conditions reduce the useful life of the card, yet issuers often want cards with lifetimes of up to 10 years. Manufacturing ID documents with such long lifetime, using known techniques and materials, adds greatly to the cost of the card.

Yet another issue with OTC manufacturing of ID documents is efficiency. In some environments, the OTC card issuing process can be at times an intermittent process. Intermittent operation of the OTC assembling process sometimes results in waste of the raw materials used to form the ID documents. Wasted raw materials increase the cost per ID card. It is possible, however, that the OTC card assembling process can be continuous, or can have intermittent periods of continuous operation).

Because many issuers of ID documents are often under budgetary pressure to keep the cost of ID documents low, while still maintaining a high quality, durable card, it would be desirable to improve the design and/or manufacture of ID documents to reduce ID document cost while maintaining ID document quality and durability.

### SUMMARY

The inventors of the instant application have found that in OTC applications, we can achieve excellent printing and durability results by using pigmented ink (versus dye based ink) for jet printing on a substrate sheet. We also have found that use of an appropriate combination of pigmented ink and substrate, as recited herein, permits printing onto substrates directly, without the need for a receiver coating or layer that is sometimes used when printing onto substrates, while still maintaining the quality and durability of the card. Eliminating the receiver coating can reduce the cost per ID document in one or more ways. In processes that use somewhat expensive substrates already having a receiver coating thereon, a cost savings can be achieved by using a less expensive “plain” substrate without the receiver coating. In processes that require a manufacturing step of applying a receiver coating, a cost savings can be achieved, because a manufacturing step is eliminated.

Elimination of the ink jet receiver layer may allow the architecture of the identification document to meet and/or exceed American Association of Motor Vehicle Administrators (AAMVA), American National Standards Institute (ANSI), and International Organization for Standardization (ISO) specifications for identification documents such as ID Cards. This is accomplished, in at least one embodiment of the invention, by not obstructing the core bonding/fusion and the lamina of an identification document with a receiver layer. By definition and design, receiver layers perform first as a receiver for the inks to be applied to the ID document. For aqueous-based jet inks, the receiver layer composition is almost always one that is negatively impacted (via swelling, etc.) by the presence of water, to the extent that the standards such as the drivers license (“DL”) standards for card integrity may not be met in wet and high temperature/high humidity environments.

At least some systems, methods, and apparatuses in accordance with embodiments of the invention produce an ID document with superior durability and tamper resistance, yet at a lower cost than presently available ID documents. In at least some embodiments, the cost of an identification document produced in accordance with the invention can cost 25% to 50% less than comparable identification documents manufactured using known techniques.

Further, at least some embodiments of the invention provide an identification document which can be issued over the counter, which can have the high quality appearance and durability of a central issue card but which can be manufactured at a lower cost than central issue cards.

At least some embodiments of the invention provide an identification document having a quality image and good durability, which can be manufactured using a microporous material but which does not necessarily require the use of a receiver layer or receiver coating.

At least some embodiments of the invention provide a method for making an over the counter card which reduces or eliminates at least some of the aforementioned problems encountered with prior art OTC documents and methods of making them.

In one embodiment, an identification document is provided that comprises a core layer and a first indicium. The core layer has a first surface, and the first indicium is printed directly onto at the first surface of the core layer. The first indicium is formed by a pigmented ink jet ink. In at least one embodiment, the pigmented ink jet ink further comprises a given substance and wherein the core layer is formed from a material having an affinity for the given substance. In at least one embodiment, the core layer is formed from a microporous material, such as TESLIN. In at least some embodiments, the core layer is formed from a material capable of accepting at least one of a phase change, solvent-based, and aqueous based ink jet inks. In at least some embodiments, the core layer has a critical surface tension between 40-60 dynes/cm.

In at least some embodiments, the first indicium is formed on the core layer such that at least a first portion of the ink jet ink is on the first surface of the core layer and a second portion of the ink jet ink is drawn into the core layer. In one embodiment, the second portion of the ink jet ink is bonded to at least a portion of the core layer. In one embodiment, the core layer comprises a material having a plurality of voids and the second portion of the ink jet ink is disposed within at least a portion of the plurality of voids.

In another aspect, the invention provides a method for preparing an identification document. A core layer is provided, the core layer comprising a given material capable of accepting ink jet ink and having a first surface. A first indicium is formed directly upon the first surface of the core material using an ink jet ink having an affinity for the given material in the core layer. Optionally, at least one layer of a substantially transparent polymer can be affixed to the first surface of the indicium-carrying core layer.

The foregoing and other features and advantages of the present invention will be even more readily apparent from the following Detailed Description, which proceeds with reference to the accompanying drawings.

### BRIEF DESCRIPTION OF THE DRAWINGS

The advantages and aspects of embodiments of the present invention will be more fully understood in conjunction with the following detailed description and accompanying drawings, wherein:

FIG. 1 is an illustrative example of a prior art identification document;

FIG. 2 is a cross section of the prior art identification document of FIG. 1, taken along the A-A line;

FIG. 3 is an illustrative example of an identification document in accordance with an embodiment of the invention;

FIG. 4 is a cross sectional view of the identification document of FIG. 3, taken along the B-B line;

FIG. 5 is an enlarged view of Section C of FIG. 4, before being printed;

FIG. 6 is an enlarged view of Section C of FIG. 4, after being printed; and

FIG. 7 is a flow diagram showing an identification document printing and assembling process according to one embodiment of the invention.

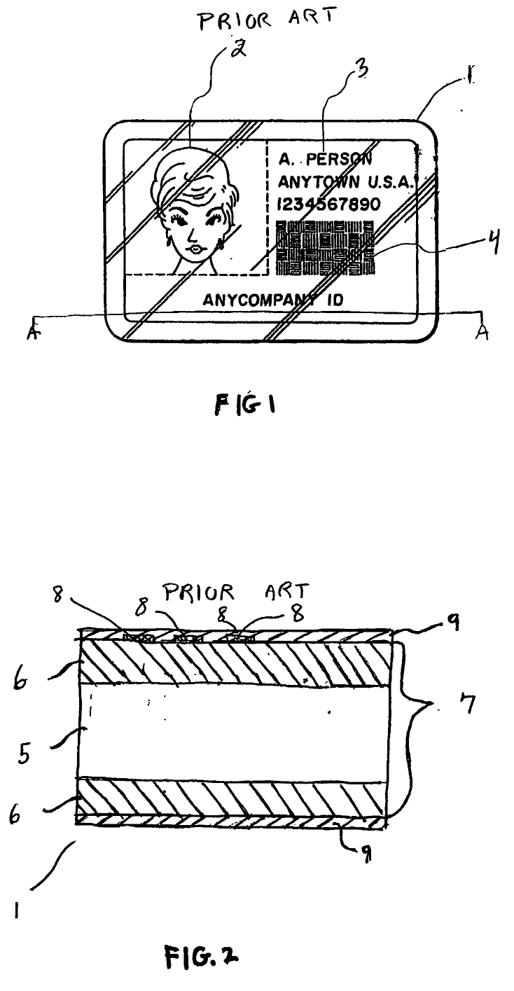

The drawings are not necessarily to scale, emphasis instead generally being placed upon illustrating the principles of the invention. In addition, in the figures, like numbers refer to like elements.

### DETAILED DESCRIPTION

In the foregoing discussion, the use of the word “card” is intended to include all types of ID documents.

(For the purposes of this disclosure, the terms “document,” “card,” “badge” and “documentation” are used interchangeably. In addition, ID document shall include, without limitation, documents, magnetic disks, CD's, or any other suitable items that may record information, images, and/or other data, which may be associated with an object or other entity to be identified.)

While ink jet printers have been available for some time now, their use in ID card printing has been limited due to several factors. Common dye based inks, as traditionally used in ink jet printers, can lack the stability to resist fading over time or under prolonged exposure to sunlight. In laminated ID cards, it is preferred that ink that is deposited on a substrate (e.g., a TESLIN sheet) not interferes with the bonding of the protective laminates that are often coupled to the substrate. Any interference may defeat security provided by the laminates or long life of the resultant ID document.

The inventors have found that dye-based ink jet inks require a so-called receiving layer (or thin coating) to be applied to the ID document substrate in order to produce a high quality print appearance. Conventional receiving layers have water absorptive characteristics that can weaken the ID card's physical integrity. For example, a card substrate that is treated with a receiving layer absorbs water, particularly at the card's edges. Absorbing water can have disastrous effects—the card can swell or warp, the laminate can peel away, a weakness point can form providing an intrusion entry point, and the printed ink can be blurred or even lost. The inventors of the instant application also have discovered that a receiving layer often weakens the bond between the substrate and laminate.

Another weakness of conventional dye based ink jet inks is the mobility of the inks in the document substrate. Often, after application to a document substrate, dye-based ink jet ink will penetrate through the entire thickness of the substrate, particularly when a receiving layer is not applied to the substrate. Ink mobility has at least two negative results. First, the ink visible on the surface of the document substrate is reduced, leading to a “washed out” image. Second, in a worst-case scenario, ink printed on a front surface of the substrate becomes visible on a back surface of the substrate.

We have discovered that the use of pigmented ink jet inks substantially eliminates or at least significantly reduces most of these issues, making such pigmented ink jet inks suitable for printing information to ID card substrates. The light and aging stability of such pigmented inks are excellent. We have also determined that a receiving layer is not required when printing with these pigmented inks, making laminate bonds to the printed substrate acceptable, while maintaining excellent moisture resistance. The pigment particles exhibit a controlled level of penetration into the substrate, such as a microporous polyethylene-polymer containing materials such as a TESLIN (manufactured by PPG Industries, Inc., of Pittsburgh, Pa.) substrate, producing excellent quality, high-density images, with little to no bleed though to the back surface of the substrate. In particular, the instant inventors have discovered

The light and aging stability of such pigments inks are excellent.

A receiving layer is not required when printing a microporous core such as a TESLIN sheet with pigment inks. Microporous core materials such as Teslin® tend to filter pigment particles out of pigmented ink leaving, in some instances, the vast majority of the ink's pigment close to the surface. Some penetration into the pores of the TESLIN does appear to occur, which aids in locking the pigment to the substrate. However, the pigmented ink penetration has been observed to be slight in comparison to traditional dye inks. The resulting bond strength of the laminate to the microporous material is excellent, and appears to be substantially unaffected by moisture.

Since the level of penetration of the pigment into the substrate can be limited, bleed through from a front surface to a back surface of the substrate has not been observed.

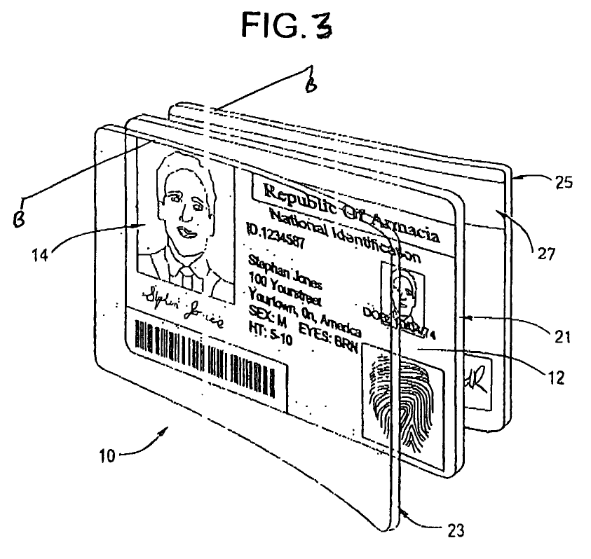

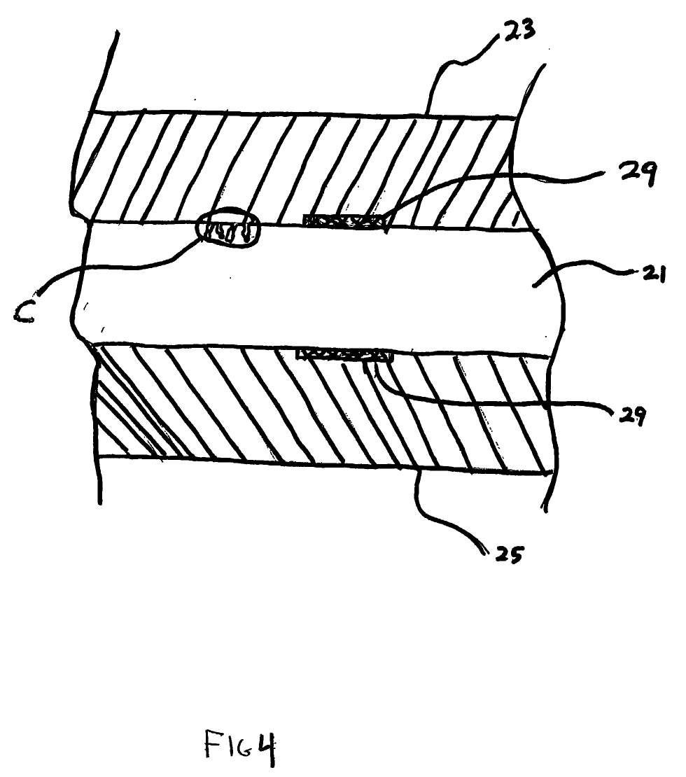

FIG. 3 is an illustrative example of an ID document 10 manufactured in accordance with one embodiment of the invention, and FIG. 4 is a cross sectional view of the identification document of FIG. 3, taken along the A-A line. The ID document 10 includes substrate 21 (which for illustrative purposes only is illustrated as having a “card-like” shape) and the ID document 10 optionally can be sealed between first and second laminate layers 23, 25 (it should be understood that the ID document 10 also may be sealed with only one laminate layer (either the first layer 23 or the second layer 25), and also may be sealed with a plurality of laminate layers.

Although not required for the instant invention, the ID document 10 may include a photograph 14 and various printed information 12, e.g., such as data, textual information, graphics, bar codes, biometric information (e.g., fingerprint), personal information (e.g., name, address, etc.), or the like. At least a portion of the photograph and/or printed information is printed on the substrate 21 with ink jet ink printing 29. In at least one embodiment, both sides of substrate 21 can receive printing 29, such as ink jet color printing or ink jet black and white printing. In some embodiments, information may also be optically or magnetically stored on recording media (e.g., magnetic stripe 27) carried by one or both of the laminates 23, 25.

Any or all of the printed information and/or images on the substrate may also include one or more built in security features, as well, to help reduce identity fraud. For example, in one embodiment of the invention, portions of the ID document 10, such as an image or a bar code, can include a digital watermark. Digital watermarking is a process for modifying physical or electronic media to embed a machine-readable code therein. The media may be modified such that the embedded code is imperceptible or nearly imperceptible to the user, yet may be detected through an automated detection process. The code may be embedded, e.g., in a photograph, text, graphic, image, substrate or laminate texture, and/or a background pattern or tint of the photo-identification document. The code can even be conveyed through ultraviolet or infrared inks and dyes.

Digital watermarking systems typically have two primary components: an encoder that embeds the digital watermark in a host media signal, and a decoder that detects and reads the embedded digital watermark from a signal suspected of containing a digital watermark. The encoder embeds a digital watermark by altering a host media signal. To illustrate, if the host media signal includes a photograph, the digital watermark can be embedded in the photograph, and the embedded photograph can be printed on a photo-identification document. The decoding component analyzes a suspect signal to detect whether a digital watermark is present. In applications where the digital watermark encodes information (e.g., a unique identifier), the decoding component extracts this information from the detected digital watermark.

Several particular digital watermarking techniques have been developed. The reader is presumed to be familiar with the literature in this field. Particular techniques for embedding and detecting imperceptible watermarks in media are detailed, e.g., in Digimarc's co-pending U.S. patent application Ser. No. 09/503,881 and U.S. Pat. No. 6,122,403. Techniques for embedding digital watermarks in identification documents are even further detailed, e.g., in Digimarc's co-pending U.S. patent application Ser. Nos. 10/094,593, filed Mar. 6, 2002, and 10/170,223, filed Jun. 10, 2002, co-pending U.S. Provisional Patent Application No. 60/358,321, filed Feb. 19, 2002, and U.S. Pat. No. 5,841,886. Each of the above-mentioned U.S. Patent documents is herein incorporated by reference.

We note that the invention encompasses ID documents including more or less features than the illustrated ID document 10.

Referring again to FIGS. 3 and 4, in at least one embodiment, the printed substrate 21 is laminated. In at least one embodiment, the finished ID document 10 includes at least a three-layer structure (e.g., laminate 23-substrate 21-laminate 25). The lamination provides a protective covering for the printed substrates and provides a level of protection against unauthorized tampering. (For example, a laminate would have to be removed to alter the printed information and then subsequently replaced after the alteration.). Various lamination processes are disclosed in assignee's U.S. Pat. Nos. 5,783,024, 6,007,660 and 6,159,327. Other lamination processes are disclosed, e.g., in U.S. Pat. Nos. 6,283,188 and 6,003,581. Each of these U.S. Patents is herein incorporated by reference.

Note, also, that the lack of “overlaminate” (e.g., overlaminate 9 as shown in FIG. 2) is one advantage of at least some embodiments of the invention, because the construction of the ID document of these embodiments is such that overlaminate is not required at all. Not using the receiver, as taught in at least some embodiments of the invention, can ensure higher ID document integrity and lower ID document cost.

The first and second laminate layers 23, 25 can be formed from any material capable of being fixedly coupled (e.g., by laminating or fusion) to the substrate 21. For example, the laminate layer 23, 25 can include a polyester or polycarbonate-based top sheet 23 and bottom sheet 25 that respectively overlay the top and bottom of the substrate 21. The first and second laminate layers 23, 25 can be coupled to the substrate 21 through virtually any means known to those skilled in the art. For example, techniques such as standard heat and pressure, pressure only, chemical fusion via solvent blending, ultraviolet (UV) methodologies, and/or electron beam (EB) methodologies can be used to laminate either or both of the first and second laminate layers 23, 25. In at least one embodiment, either or both of the first and second laminate layers 23, 25 can have a size of any caliper from about 1 mil or less to in excess of 20 mils. In at least one embodiment, for a practical implementation of lamination or fusion of the first and second laminates 23, 25, to the substrate 21, the size of each laminate layer 23, 25 is in a range of 1-15 mils.

In at least some embodiments, the ink jet printed substrate can be over laminated with known laminate material, such as polyester laminates or polycarbonates. In one embodiment, the laminated substrate 21 is formed such that it can be die cut into a typical ID card size (e.g., conforming to an ISO standard). In one embodiment, the laminate layers 23, 25 are optically clear durable plastic films, such as amorphous or biaxially oriented polyester.

In at least one embodiment, the ID document in accordance with the invention can be formed by reverse-printing the laminate with one or more indicia (e.g., information about the card bearer, images, invariate information, etc.) and bonding the laminate directly to the substrate.

In at least some embodiments, the laminate layers 23, 25 provide additional security features for the identification document 10. For example, either or both of the laminate layers 23, 25 may include a low cohesivity polymeric layer, an optically variable ink, an image printed in an ink which is readable in the infra-red or ultraviolet but is invisible in normal white light, an image printed in a fluorescent or phosphorescent ink, or any other available security feature which protects the document against tampering or counterfeiting, and which does not compromise the ability of the protective layer to protect the identification document against wear and the elements

In at least one embodiment, instead of the first and second laminate layers 23, 25, the laminate is formed from a pouch into which the substrate 21 slips. With a pouch, methods such as heat, pressure, adhesives, and the like, are usable to bond the substrate 21 with the pouch laminate.

In at least one embodiment of the invention, the jet ink used to print the substrate 21 is an aqueous pigmented jet ink. An aqueous pigmented ink formulation usable in at least some embodiments of the invention generally includes, e.g., water, water miscible organic solvent such as alcohols, acetone, ketones, ketoalcohols, ethers, esters nitrogen containing compounds or sulfur containing compounds in a portion of about 10 to 30%, at least one pigment for individual Cyan, Magenta, or Yellow (the pigments can be organic or inorganic compounds), dispersants or surfactants to stabilize the pigments, viscosity modifiers, biocides, defoamers, drying agents, agents to modify conductivity, and the like. Many different types of inks, containing pigments suspended in any one or more of many different types of vehicles (e.g., water, alcohol, etc.) are usable in accordance with the invention, as those skilled in the art will appreciate. In addition, at least one embodiment of the invention is implemented using so-called “quick drying” ink jet inks, such as UV-curable ink jet inks. Quick drying ink jet inks can be particularly useful with materials such as PVC and PET. In addition, non-liquid ink jet inks and phase change ink jet inks (e.g., pellets that can be heated to form an ink capable of flowing through nozzles) are, of course, usable in at least some embodiments of the invention.

In at least one embodiment, the concentration of the pigment in each ink is preferred to be in the range of 1% to 10%. This range can be acceptably expanded to about 1% to 20%, but at a sacrifice of print head nozzle life due to clogging. In one embodiment, the pigment particle size is preferably less than about 1 micron (e.g., a small particle size helps to prevent nozzle clogging and improve printing characteristics). In at least some embodiments, however, particle sizes between 1-10 microns are usable with the invention. Each ink formulation may contain, e.g., 10 to 100% by weight of dispersants on the pigment.

Of course, the pigmented ink jet ink need not be aqueous ink. Other types of inks usable in accordance with embodiments of the invention include phase change ink jet inks and solvent-based ink jet inks.

The substrate 21 (also referred to herein as “printed core”) can be formed wholly or partially from any material that can accept phase change, solvent-based, and/or aqueous based ink jet inks, or any material that is constructed and arranged in such a manner that it accepts, wholly or partially, phase change, solvent-based, and/or aqueous based ink jet inks. In one embodiment, the substrate 21 is constructed using a two phase material; for example, a material having one phase that is hydrophobic and one phase that is hydrophilic, used with aqueous based ink jet inks. In one embodiment, the substrate 21 is constructed using a single phase material and is formed into an identification card using a quick-drying ink (e.g., a substrate 21 formed from PVC in combination with UV curable ink jet inks).

In one embodiment, the substrate 21 (also referred to as core layer) includes a material having an affinity for at least one substance in the pigmented ink, such as the vehicle carrying the particles of pigment. By affinity, it is at least meant that at least part of the substrate 21 does not repel the vehicle carrying the particles in the ink jet ink. For example, a material such as TESLIN, because of its construction, has an affinity for aqueous based ink jet inks. In at least one embodiment, the substrate 21 is a microporous material having a pore or void volume, whereby at least part of the ink jet ink applied to the substrate 21 flows into one or more of the voids or pores in the microporous material. For example, in one embodiment, the pigmented ink is water-based and the substrate sheet is made from a hydrophilic material such, a TESLIN sheet. In at least one embodiment, the hydrophilic material is a material having a surface tension in a range of 40 to 60 dynes/cm, such as a surface tension of about 50 dynes/cm.

We have found that the invention described herein can be used, depending on the type of ink jet ink used, with substrates made of a variety of materials, including a variety of microporous materials, single phase materials, two phase materials, paper, paper having a porous coating, synthetic paper (e.g., TYVEC, manufactured by Dupont Corp of Wilmington, Del.), paper coated with a porous resin, foamed polypropylene film (including calcium carbonate foamed polypropylene film), plastic, polyolefin, polyester, polyethylenetelphthalate (PET), and polyvinyl chloride (PVC). The applications of pigmented inks described herein are usable with virtually any substrate, pigmented ink jet ink, and/or laminate used in the manufacture of identification documents. For example, those skilled in the art will appreciate that virtually any type of inkjet receiving element, including both transparent and opaque elements, can be used as a substrate in accordance with some embodiments of the invention.

By using a microporous material having an affinity for the type of jet ink used (e.g., a hydrophilic material for aqueous-based inks), the jet ink is bonded both on top of and into the substrate 21. This is because when the jet ink is applied to the microporous material, at least a portion of the jet ink (e.g., at least a portion of the vehicle in the ink jet ink that carries the particulate or particles) is drawn (via a wicking action similar to capillary action) into the microporous structure of the substrate 21, while at least a portion of the particulate in the jet ink (such as the color or black pigment) remain on “top” of the substrate. For example, using an aqueous-based jet ink, the water (along with at least a portion of the binder in the jet ink) is drawn into the pores in the substrate 21, while the pigments in the ink remain on “top” of the substrate 21.

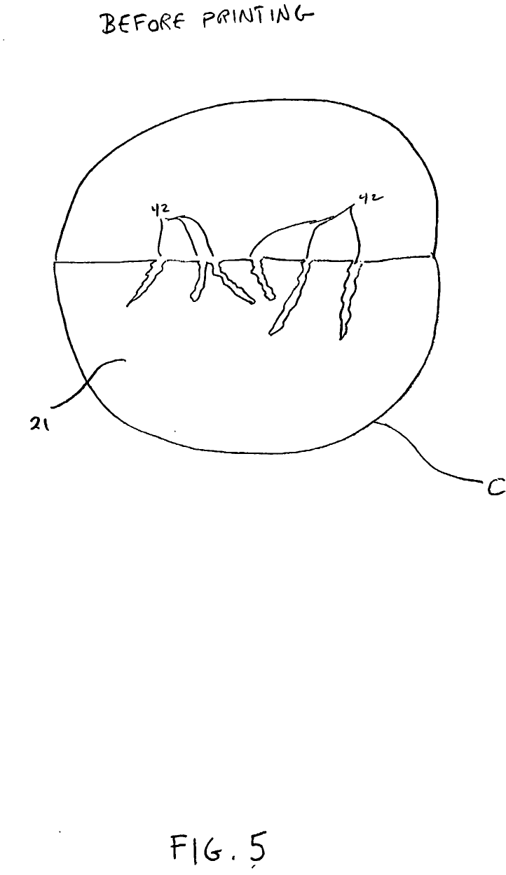

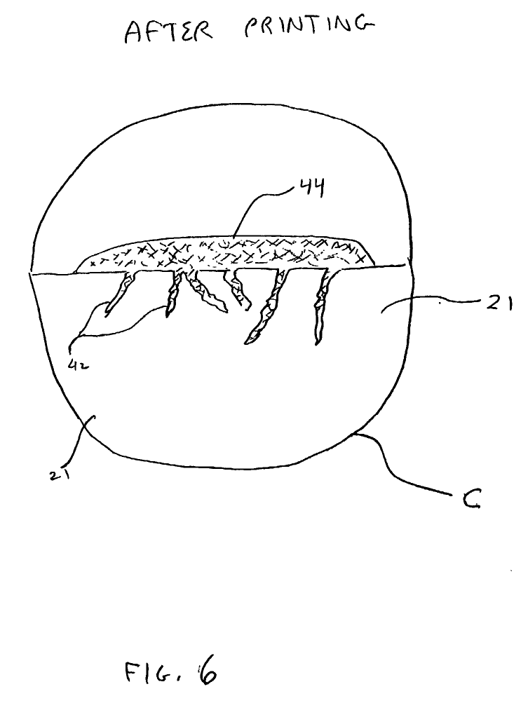

This is illustrated by way of example in FIGS. 5 and 6. FIG. 5, is an enlarged view of Section C of FIG. 42, before being printed, and shows the appearance of the pores 42 in the substrate 21 before printing. FIG. 6 is an enlarged view of Section C of FIG. 4 after being printed. Note in FIG. 6 that a portion of the jet ink 44 has been drawn into the pores 42 and a portion of the jet ink 44 remains on “top” of the substrate 21).

When considering the security advantages of a laminate, in at least some embodiments of the invention, it is desirable that tampering with the card (e.g., trying to remove a laminate to change the printing) results in obvious evidence of the tampering. We have found that not only is the bond strength of a laminate to the pigmented ink jet printed microporous material (such as TESLIN) excellent, but the mode of failure when stressed to failure is a highly desirable mode. For example, the failure mode for laminated pigmented ink jet printed TESLIN is a fracture line occurring either down the thickness of the TESLIN, or a fracturing line occurring down the thickness of the ink, making cleanup and subsequent altering very difficult. (If the laminate were to come off cleanly, with the ink residing intact on the TESLIN, or if the ink were to transfer 100% to the adhesive, then only one surface would have to be cleaned and altered, which is a much easier alteration to do.). Generally a combination of both fracturing modes occurs. All of these fracturing modes make alterations quite obvious, photo replacement or data changing very difficult, and relamination impossible without adding an adhesive layer.

Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. The laminate can comprise a plurality of separate laminate layers, for example a boundary layer and/or a film layer. The degree of transparency of the laminate can, for example, be dictated by the information contained within the identification document, the particular colors and/or security features used, etc. Of course, the types and structures of the laminates described herein are provided only by way of example, those skilled in the art will appreciated that many different types of laminates are usable in accordance with the invention.

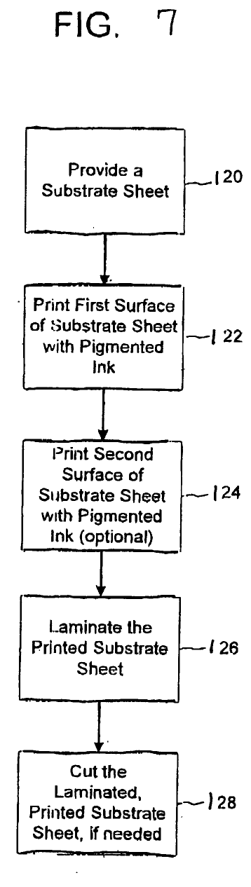

In another aspect, at least some embodiments of the invention include methods and processes for printing and assembling identification documents. FIG. 7 is a flow diagram showing an identification document printing and assembling process according to one embodiment of the invention.

The process starts by providing a substrate sheet (for example, a TESLIN substrate sheet or any of the other usable materials previously described) for ink jet printing (step 120). The ID document substrate 21 is formed from the substrate sheet. The sheet can be larger than the size of a finished card, if needed. This over-sizing allows ample room for the substrate to be handled, printed and laminated, and then trimmed to a specified size. A first side of the substrate sheet is printed using pigmented ink jet ink (step 122). Virtually any mechanism capable of applying jet ink to a substrate is usable in accordance with the invention. In one embodiment, the jet ink is printed on to the card by a first ink jet printer having a supply of pigmented ink jet ink. For example, one type of ink jet printer usable with at least some embodiments of the invention ejects liquid drops of jet ink from one or more nozzles or orifices in a print head of an ink jet printer. The printing can be even carried out in multiple colors, corresponding to respective colored pigmented ink jet ink colors. Optionally, a second side of the substrate sheet is printed using pigmented ink jet ink (step 124). In at least one embodiment, a second ink jet printer is used to print to the second side of the substrate sheet. Or course, those skilled in the art will appreciate that the system for printing ID document substrates described herein can be constructed and arranged to print both sides of the substrate from a single ink jet printer. If the given identification document is to be laminated, then the printed substrate sheet optionally is then laminated (step 126). The laminate preferably protects each printed side of the substrate.

In one embodiment, following lamination, the laminated, printed substrate is cooled and is cut (e.g., by die-cutting) to a specified size (step 128). In at least one embodiment, however, the substrate and laminate can be sized such that cutting the laminated printed substrate is not necessary.

The identification documents of the invention may be manufactured in any desired size. For example, identification documents can range in size from standard business card size (47.6.times.85.7 mm) up to identification booklet documents (127.times.177.8 mm), and can have thicknesses in the range of from about 0.3 to about 1.3 mm. At least some identification documents produced in accordance with embodiments of the invention conform to all the requirements of ISO 7810, 1985 and will thus be of the CR-80 size, 85.47-85.73 mm wide, 53.92-54.03 mm high and 0.69-0.84 mm thick. The corners of such CR-80 documents are rounded with a radius of 2.88-3.48 mm

### CONCLUDING REMARKS

Having described and illustrated the principles of the technology with reference to specific implementations, it will be recognized that the technology can be implemented in many other, different forms, and in many different environments.

We note that some conventional black ink jet inks are pigmented inks. For example, we have found that some black inks obtained from HP (81 and 83 black inks), Canon (BCI-5BK), and Epson (T015) are suitable for printing on a Teslin® ID document substrate. Similarly, we have found that color pigmented inks (CMY) for the Epson 2000P printer (T106) and for the HP DesignJet 5000 printer (HP 81, and 83 cyan, magenta, yellow inks) are suitable for our inventive ID document ink jet printing needs.

We expressly contemplate that the inventive techniques disclosed herein will be combined with the techniques disclosed in commonly assigned provisional patent application having serial No. 60/379,646, entitled “Identification Card Printer-Assembler For Over-The-Counter Card Issuing” (Attorney Docket No. P6012—Inventors: Dennis Mailloux, Daoshen Bi and Robert Jones).

To provide a comprehensive disclosure without unduly lengthening the specification, applicants herein incorporates by reference each of the U.S. patent documents referenced above.

Although certain words, languages, phrases, terminology, and product brands have been used herein to describe the various features of the embodiments of the invention, their use is not intended as limiting. Use of a given word, phrase, language, terminology, or product brand is intended to include all grammatical, literal, scientific, technical, and functional equivalents.

The particular combinations of elements and features in the above-detailed embodiments are exemplary only; the interchanging and substitution of these teachings with other teachings in this and the incorporated-by-reference patent documents are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

What is claimed is:

1. An identification document comprising:
a core layer having a first surface;
a first indicium printed directly onto at least a portion of the first surface of the core layer, the first indicium formed by a pigmented ink jet ink.

2. The identification document of claim 1 wherein the pigmented ink jet ink further comprises a given substance and wherein at least a portion of the core layer comprises a material having an affinity for the given substance.

3. The identification document of claim 1 wherein the ink jet ink comprises a vehicle and a plurality of particles dispersed in the pigment and wherein at least a portion of the core layer is constructed and arranged to have an affinity for the vehicle.

4. The identification document of claim 1 wherein at least a portion of the core layer comprises a microporous material.

5. The identification document of claim 1 wherein at least a portion of the core layer comprises a material capable of accepting at least one of a phase change, solvent-based, and aqueous based ink jet inks.

6. An identification document according to claim 1 wherein at least a portion of the core layer comprises a silica-filled polyolefin.

7. The identification document of claim 1 wherein at least a portion of the core layer comprises TESLIN.

8. The identification document of claim 1 wherein the core layer comprises at least one of single phase materials, two phase materials, paper, paper having a porous coating, synthetic paper, TYVEC, paper coated with a porous resin, foamed polypropylene film, plastic, polyolefin, polyester, polyethylenetelphthalate (PET), and polyvinyl chloride (PVC).

9. The identification document of claim 1 wherein the core layer has a surface tension between 40-60 dynes/cm.

10. The identification document of claim 1, wherein the first indicium is formed on the core layer such that at least a first portion of the ink jet ink is on the first surface of the core layer and a second portion of the ink jet ink is drawn into the core layer.

11. The identification document of claim 10, wherein the second portion of the ink jet ink is bonded to at least a portion of the core layer.

12. The identification document of claim 11, wherein the ink jet ink comprises a vehicle carrying a plurality of particles and wherein the second portion of the ink jet ink comprises at least a portion of the vehicle of the ink jet ink.

13. The identification document of claim 11 wherein the core layer comprises a material having a plurality of voids and wherein the second portion of the ink jet ink is disposed within at least a portion of the plurality of voids.

14 The identification document of claim 11 wherein the second portion of the jet ink is smaller than the first portion of the jet ink.

15. The identification document of claim 1, further comprising a first layer fixed to the core layer on the first surface thereof, the first layer comprising a substantially transparent polymer.

16. The identification document of claim 15 wherein the first layer further comprises a substantially transparent adhesive.

17. The identification document of claim 1 further comprising a plurality of laminate layers fixed to the core layer on the first surface thereof.

18. The identification document of claim 1 further comprising a first layer affixed to the first surface, the first layer comprising a protective film layer and a boundary layer.

19. The identification document of claim 1 further comprising a first layer fixed to core layer on the first surface thereof, the first layer comprising a co-extruded, substantially transparent polymer.

20. The identification document of claim 15 wherein the core layer has a second surface and wherein the identification document further comprises a second layer of a substantially transparent polymer fixed to the core layer on the second surface thereto.

21. The identification document of claim 1 wherein the core layer has a second surface and wherein the identification document further comprises a second indicium printed onto at least a portion of the second surface of the core layer, the second indicium formed by a pigmented ink jet ink.

22. The identification document of claim 21 wherein the identification document further comprises a second layer of a substantially transparent polymer fixed to the core layer on the second surface thereto.

23. The identification document of claim 1 wherein the core layer does not comprise a receiver and wherein the indicium is printed onto the core layer without using a receiver.

24. A method for preparing an identification document, comprising:
providing a core layer having a first surface, the core layer comprising a material capable of accepting a given ink jet ink and having an affinity for at least one substance in the ink jet ink; and
forming at least one first indicium directly upon the first surface of the core material using the ink jet ink for which the core layer has an affinity.

25. The method of claim 24, further comprising affixing to the indicium-carrying core layer at least one layer of a substantially transparent polymer affixed to the first surface of the core layer.

26 The method of claim 24, wherein the concentration of the pigment in the ink is in a range of 1% to 20%.

27. The method of claim 24 wherein the pigment particle size is less than 1 micron.

28. The method of claim 24 wherein the pigment particle size is between 1 to 10 microns.

29. The method of claim 24, wherein the ink formulation comprises 10 to 100% by weight of dispersants on the pigment.

30. An identification document, comprising
a core layer having a first surface; and
means for conveying information directly formed on the first surface of the core layer.
